(19) United States
(12) Patent Application Publication
(10) Pub. No.: US 2004/0203653 A1
(43) Pub. Date: Oct. 14, 2004

(54) METHOD FOR AUTOMATICALLY COMPLETING SETTINGS OF NETWORK PARAMETERS IN WIRELESS TERMINALS

(76) Inventors: Cheng-Shing Lai, Taipei Hsien (TW); Ji-Dong Qin, Nanjing (CN); Xiao-Long Fan, Nanjing (CN)

Correspondence Address: NAIPO (NORTH AMERICA INTERNATIONAL PATENT OFFICE), P.O. BOX 506, MERRIFIELD, VA, 22116, US

(21) Appl. No.: 10/249,127

(22) Filed: Mar. 18, 2003

(51) Int. Cl. H04M 3/42; H04M 3/00; H04Q 7/20

(52) U.S. Cl. 455/414.1; 455/419; 455/433

(57) ABSTRACT

A method for automatically completing settings of network parameters of wireless terminals with a server in a wireless network system. Each wireless terminal corresponds to a specific setting of network parameters. The server includes a data storage module and a central processor. The method includes: (a) utilizing the wireless terminal to connect to the server and to transmit a request signal to the server, (b) utilizing the central processor to pick a set of parameters corresponding to the wireless terminal from the data storage module according to the request signal, (c) utilizing the server to return the set of parameters to the wireless terminal, and (d) completing the setting of network parameters in the wireless terminal.

### BACKGROUND OF INVENTION

1. Field of the Invention

The present invention relates to a method for automatically completing a plurality of settings of network parameters corresponding to a plurality of wireless terminals in a wireless network system, and more particularly, to a method of using a server that stores a plurality of sets of network parameters corresponding to settings of the network parameters of the wireless terminal for automatically completing the settings of the network parameters of the wireless terminals.

2. Description of the Prior Art

With the advent of the broadband-communication era, wireless service has become a major target for various wireless-communication providers. In addition to a GPRS (General Packet Radio Services) technique and a WAP (Wireless Application Protocol) technique for providing wireless service, all other kinds of designs and architectures are constantly developed by related manufacturers and wireless service providers. The development and competition lead to easier operations and more powerful functions for users to perform wireless services on either portable devices or fixed devices.

Nowadays, most of the wireless terminals support wireless services, including wireless connection, e-mail receiving/transmitting, and so on. When the user wants to utilize functions related to wireless services, the user has to previously complete corresponding settings of the network parameters, such as the login name, passwords, and server address. However, for the general users, they will be confused by some professional items as “POP3 server”, “SMTP server”, and “IMAP4 server”, when performing settings of the network parameters in the wireless terminals.

### SUMMARY OF INVENTION

It is therefore a primary objective of the claimed invention to provide a method for automatically completing settings of network parameters in a plurality of wireless terminals with a server in a wireless network system to solve the above-mentioned problem.

The claimed invention provides installation of a server in a wireless network system for automatically completing settings of the network parameters in the wireless terminals. A plurality of sets of network parameters are stored in a data storage module of the server, and the IP address of the server is built in the wireless terminals. When the user of the wireless terminal selects to automatically complete all the related settings, the wireless terminal will be connected to the server in the wireless network system, and the sever will search the corresponding set of network parameters so that the wireless terminal is allowed to complete the setting of the network parameters with the received set of network parameters.

According to the claimed invention, a method is used for automatically completing settings of network parameters in a plurality of wireless terminals with a server in a wireless network system, the wireless network system comprising the plurality of wireless terminals, each wireless terminal corresponding to a setting of the network parameter, the server comprising a data storage module for storing a plurality of sets of network parameters, each set of network parameters corresponding to a setting of the network parameters of a wireless terminal, and a central processor for controlling operations of the server; the method comprising (a) utilizing the wireless terminal to wirelessly connect to the server and to transmit a request signal to the server; (b) after step (a), according to the request signal, utilizing the central processor to pick a set of network parameters corresponding to the wireless terminal from the data storage module;(c) after step (b), utilizing the server to transmit the set of network parameters to the wireless terminal; and(d) after step (c), utilizing the set of network parameters to complete the setting of the network parameters of the wireless terminal.

It is an advantage of the claimed invention that the method can automatically complete settings of network parameters in wireless terminals via wireless service. Therefore, users do not have to understand those confusing settings and parameters, and can quickly and easily complete settings of network parameters in the wireless terminals by accessing a server stored with a plurality of sets of network parameters.

These and other objectives and advantages of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a wireless network system according to the present invention.

FIG. 2 is a flowchart showing users making use of the server to automatically complete the setting of the network parameters of the wireless terminal.

FIG. 3 is a flowchart of a practical embodiment of the present invention.

FIG. 4 is a flowchart of another practical embodiment of the present invention.

### DETAILED DESCRIPTION

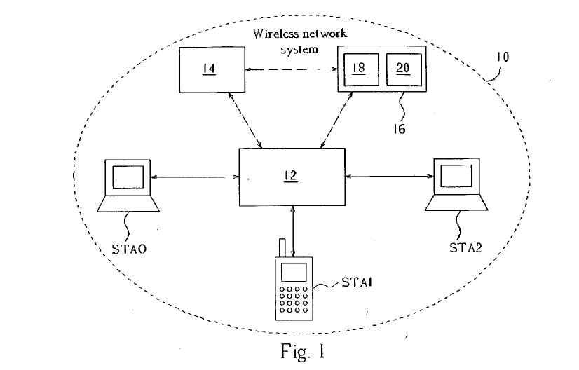

The characteristics of the present invention can be accomplished in a wireless network system. In brief, information and data can be delivered in the wireless network system with the form of EM waves or infrared light without the concrete connections among the terminals. In the wireless network system, a server can wirelessly receive/transmit signals through access points for providing wireless services. Similarly, the wireless terminals that are designed for wireless connection have to be equipped with devices for wirelessly emitting/receiving signals. For example, a PC and a notebook can wirelessly emit/receive signals with installation of wireless adapters. Please refer to FIG. 1, which is a schematic diagram of a wireless network system 10 according to the present invention. The wireless network system includes a plurality of wireless terminals STA0, STA1, STA2, and the wireless terminals STA0, STA1, STA2 can be PCs, notebooks, PDAs, or mobile phones with functions of wireless connection. Each of the wireless terminals corresponds to a specific setting of the network parameters. The wireless network system 10 includes an access point 12 and a network controller 14. The network controller 14 takes charge of the access of resources and operations of the wireless network system 10, and the access point 12 is wirelessly/wiredly connected to the network controller 14 for wirelessly emitting/receiving signals in the wireless network system 10. Within an effective region of the access point 12, the signals emitted from the access point 12 can be received by the wireless terminals, and the signals emitted from the wireless terminals can be received by the access point 12 and transmitted to the network controller 14 for advanced processing. Therefore, the wireless terminals can effectively access network resources of the wireless network system 10.

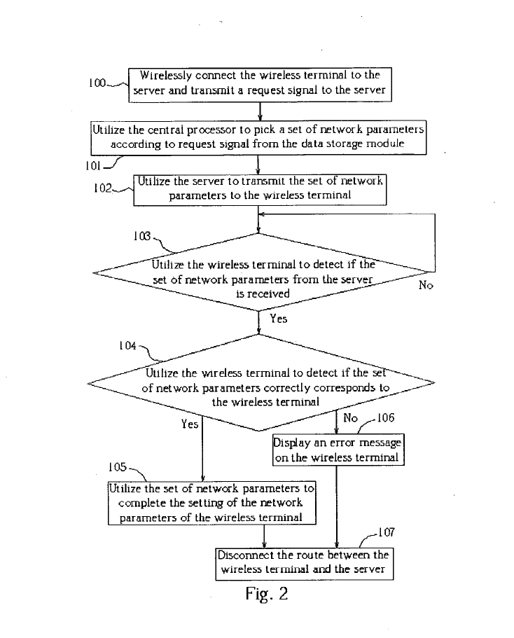

Please continue referring to FIG. 1 The wireless network system 10 further includes a server 16, which can communicate with the access point 12 through the network controller 14 or directly communicate with the access point 12. The server 16 is the major characteristic of the present invention. The users of the wireless terminals STA0, STA1, STA2 can make use of related data stored in the server 16 to automatically complete the settings of the network parameters of the wireless terminals STA0, STA1, STA2. The server 16 includes a data storage module 18 and a central processor 20. The data storage module 18 is used for storing a plurality of set of network parameters, and each set of network parameters corresponds to a specific setting of the network parameters of a certain wireless terminal. In addition, the central processor 20 is used for controlling operations of the server 16. Please refer to FIG. 2, which is a flowchart showing how a user makes use of the server 16 as shown in FIG. 1 to automatically complete the setting of the network parameters of the wireless terminal. The operation comprises following steps:

Step 100: Utilize the wireless terminal to wirelessly connect to the server 16, and to transmit a request signal to the server 16;

Step 101: After step 100, utilize the central processor 20 to pick a set of network parameters corresponding to the wireless terminal according to request signal from the data storage module 18;

Step 102: After step 101, utilize the server 16 to transmit the picked set of network parameters to the wireless terminal;

Step 103: After step 102, utilize the wireless terminal to detect if the set of network parameters from the server 16 is received. If the result is positive, proceed to step 104, otherwise proceed to step 103;

Step 104: Utilize the wireless terminal to detect if the set of network parameters correctly corresponds to the wireless terminal. If the result is correct, proceed to step 105, otherwise proceed to step 106;

Step 105: Utilize the set of network parameters to complete the setting of the network parameters of the wireless terminal, go to step 107;

Step 106: Display an error message on the wireless terminal;

Step 107: Disconnect the route between the wireless terminal and the server 16.

Please notice that, first, the data storage module 18 of the server 16 is stored with an IP address of the server 16, which is used for locating the server 16 in the wireless network system 10. In addition, the IP address of the server 16 is built in the wireless terminal for the user to easily wirelessly connect the wireless terminal to the server 16. Therefore, the IP address of the server 16 has to be relatively fixed. Moreover, in step 103, if the time for the wireless terminal to wait for the server 16 transmitting the set of network parameters exceeds a predetermined period of time, an error message will be displayed on the wireless terminal, and the connection between the wireless terminal and the server 16 will be disconnected.

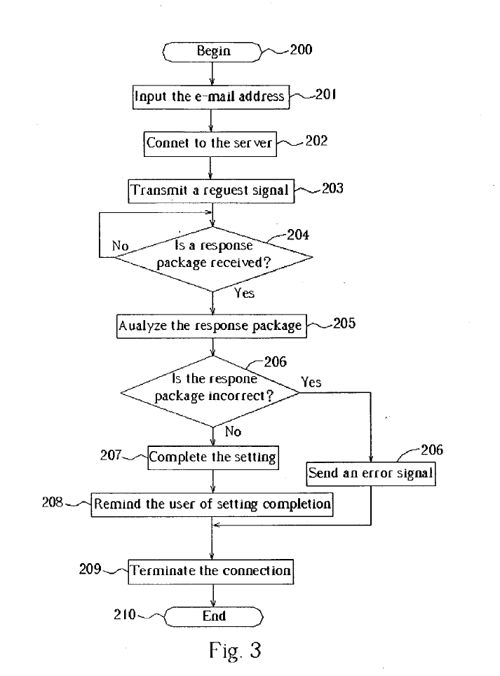

The setting of the network parameters of the wireless terminal includes a connecting setting, an MMS setting, a SyncML setting, a VPN (Virtual Private Network) setting, a server setting, a music-channel setting, and so on. The user can choose to complete all the settings or just partial settings of the network parameters. Please refer to FIG. 3, which is a flowchart of a practical embodiment of the present invention. The present embodiment operates from a viewpoint of the wireless terminal, and takes the related settings of e-mail for instance. The present embodiment comprises following steps:

Step 200: Begin;

Step 201: The user inputs the e-mail address (or login parameters and passwords). For instance, after the e-mail address of the user “abc@sohu.com” is inputted, the server 16 can make use of the e-mail address to pick a corresponding data from the data storage module 18, and all the other settings related to the e-mail address can be completed by the method of the present invention;

Step 202: After the user chooses the automatic setting completion, the wireless terminal can connect to Internet and built a connection between the server 16 via a dialing, WAP, or GPRS technique;

Step 203: Transmit a request signal to the server 16, and the request signal includes the e-mail address (abc@sohu.com);

Step 204: Wait for a response package from the server 16. After the response package is received, proceed to step 205, otherwise keep waiting;

Step 205: Analyze the response package. (At the server 16, after the server 16 receives the request signal, the corresponding response package will be picked from the data storage module 18. For instance, in the data storage module 18, the response package corresponding to the request signal (the e-mail address: abc@sohu.com) includes a POP3 setting “pop.sohu.com”, an SMTP setting “smtp.sohu.com”, an IMAP4 setting “imap.sohu.com”. All the above-mentioned settings are included in the response package. If the server 16 cannot find the corresponding response package, an error signal will be transmitted to the wireless terminal);

Step 206: Judge if the response package is incorrect. If the response package is correct, proceed to the next step, otherwise the error signal is displayed on the wireless terminal and the connection between the wireless terminal and the server 16 is terminated;

Step 207: Save the response package and complete the related settings;

Step 208: Remind the user of the completion of the related settings;

Step 209: Terminate the connection between the wireless terminal and the server 16; Step 210: End.

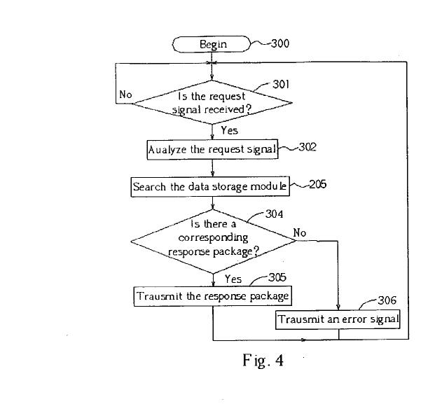

Please refer to FIG. 4, which is a flowchart of another practical embodiment of the present invention. The present embodiment operates from a viewpoint of the server 16, and also takes the related settings of e-mail for instance. The present embodiment comprises following steps:

Step 300: Begin;

Step 301: Judge if the request signal (transmitted from the wireless terminal) is received. For instance, the request signal includes the e-mail address: abc@sohu.com. If the request signal is received, proceed to step 302, otherwise keep waiting;

Step 302: Analyze the request signal;

Step 303: Search the data storage module 18;

Step 304: Judge if there is any corresponding response package; if so, go to step 305; if not, go to step 306;

Step 305: If there is a corresponding response package in the data storage module 18, the response package will be transmitted to the wireless terminal, (for instance, in the data storage module 18, the response package corresponding to the request signal (the e-mail address: abc@sohu.com) includes a POP3 setting “pop.sohu.com”, an SMTP setting “smtp.sohu.com”, an IMAP4 setting “imap.sohu.com”) and then proceed to step 301;

Step 306: If there is no corresponding response package in the data storage module 18, an error signal is transmitted to the wireless terminal and then proceed to step 301.

Please notice that the amount of the servers in the wireless network system shall not be limited. Users of the wireless terminals can automatically complete settings of network parameters in wireless terminals via wireless service. Therefore, users do not have to understand those confusing settings and parameters, and can quickly and easily complete settings of network parameters in the wireless terminals by accessing a server stored with a plurality of sets of network parameters.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for automatically completing settings of network parameters in a plurality of wireless terminals with a server in a wireless network system, the wireless network system comprising the plurality of wireless terminals, each wireless terminal corresponding to a setting of the network parameter, the server comprising:
a data storage module for storing a plurality of sets of network parameters, each set of network parameters corresponding to a setting of the network parameters of a wireless terminal; and
a central processor for controlling operations of the server;
the method comprising:
(a) utilizing the wireless terminal to wirelessly connect to the server and to transmit a request signal to the server;
(b) after step (a), according to the request signal, utilizing the central processor to pick a set of network parameters corresponding to the wireless terminal from the data storage module;
(c) after step (b), utilizing the server to transmit the set of network parameters to the wireless terminal; and
(d) after step (c), utilizing the set of network parameters to complete the setting of the network parameters of the wireless terminal.

2. The method of claim 1 further comprising:
(e) after step (c), utilizing the wireless terminal to judge if the set of network parameters from the server is received, if the result is positive, then proceeding to step (f), otherwise proceeding to step (e); and
(f) utilizing the wireless terminal if the set of network parameters correctly corresponds to the wireless terminal, if the result is correct, then proceeding to step (d)and disconnecting the connection between the wireless terminal and the server, otherwise not proceeding to step (d), displaying an error message on the wireless terminal, and disconnecting the connection between the wireless terminal and the server.

3. The method of claim 2 wherein in step (e), if the time for the wireless terminal to wait for the server to transmit the set of network parameters exceeds a predetermined period of time, an error message will be displayed on the wireless terminal, and the connection between the wireless terminal and the server will be disconnected.

4. The method of claim 1 wherein step (a) is executed by a GPRS (General Packet Radio Services) technique or a WAP (Wireless Application Protocol) technique.

5. The method of claim 1 wherein the wireless network system is an internet infrastructure.

6. The method of claim 1 wherein the data storage module further stores an IP address of the server for locating the server in the wireless network system.

7. The method of claim 6 wherein the IP address of the server is built in the wireless terminal.

8. The method of claim 1 wherein the settings of the network parameters of the wireless terminal comprise a connecting setting, an MMS setting, a SyncML setting, a VPN (Virtual Private Network) setting, a server setting, and a music-channel setting.

9. The method of claim 1 wherein the wireless terminal is a PC with wireless-connecting function, a portable computer, a PDA, or a mobile phone.
